(19) United States
(12) Patent Application Publication
(10) Pub. No.: US 2022/0264707 A1
(43) Pub. Date: Aug. 18, 2022

(54) INDUCTION HEATING APPARATUS AND METHOD FOR CONTROLLING INDUCTION HEATING APPARATUS

(71) Applicants: LG ELECTRONICS INC., Seoul (KR); UNIST (ULSAN NATIONAL INSTITUTE OF SCIENCE AND TECHNOLOGY), Ulsan (KR)

(72) Inventors: Mina KIM, Ulsan (KR); Kyelyong Kang, Seoul (KR); Jinwook Han, Seoul (KR); Sihoon Jeong, Seoul (KR); Jee Hoon Jung, Ulsan (KR)

(21) Appl. No.: 17/674,062

(22) Filed: Feb. 17, 2022

(30) Foreign Application Priority Data
Feb. 18, 2021 (KR) 10-2021-0022101

(51) Int. Cl. H05B 6/06; H05B 6/12

(52) U.S. Cl. CPC H05B 6/062; H05B 2206/02; H05B 6/1209

(57) ABSTRACT

An induction heating apparatus may receive a power level input for a heating area, determine a required power value corresponding to the power level, determine a heating frequency corresponding to the required power value, and set a driving frequency of the working coil to an initial frequency determined based on the heating frequency and then drive the working coil. The driving frequency may be changed from a current driving frequency to a target frequency based on a predetermined frequency change cycle.

### CROSS-REFERENCE TO RELATED APPLICATION

This application claims priority under 35 U.S.C. § 119 to Korean Application No. 10-2021-0022101, filed on Feb. 18, 2021, whose entire disclosure is hereby incorporated by reference.

### BACKGROUND

### 1. Field

Disclosed herein are an induction heating apparatus and a method for controlling the same.

### 2. Background

An induction heating apparatus generates eddy current in a container made of metal by using a magnetic field generated around a working coil to heat the container. As an induction heating apparatus operates, alternating current is supplied to a working coil. Accordingly, an induction magnetic field is generated around the working coil disposed in the induction heating apparatus. As the magnetic line of force of the generated induction magnetic field passes through the bottom of the container (including a metallic ingredient) provided on the working coil, eddy current is generated inside the bottom of the container. As the generated eddy current flows in the container, the container itself is heated.

Electromagnetic signals or electromagnetic noise, generated by an electronic device such as an induction heating apparatus, can cause disturbance in the receipt of electromagnetic signals of another electronic device (i.e., electromagnetic interference (EMI)). Standards have been prepared to reduce electromagnetic interference and ensure electromagnetic compatibility. For example, a level of EMI generated during the driving of an induction heating appliance may need to comply with CISPR 14-1 set by the International Special Committee on Radio Interference (CISPR). To satisfy the requirements in CISPR 14-1, the induction heating apparatus may need to reduce the level of EMI generated during its driving.

To reduce the level of EMI of the induction heating apparatus, a method of changing a driving frequency of a working coil has been suggested. For example, a method by which a level of EMI generated in a low-frequency band (9 kHz-150 kHz) decreases by changing a driving frequency of a working coil of the induction heating apparatus on a regular basis is disclosed in a Document 1 (L. A. Barragan, D. Navarro, J. Acero, I. Urriza and J. M. Burdio, “FPGA Implementation of a Switching Frequency Modulation Circuit for EMI Reduction in Resonant Inverters for Induction Heating Appliances,” in IEEE Transactions on Industrial Electronics, vol. 55, no. 1, pp. 11-20, Jan. 2008, doi: 10.1109/TIE.2007.896129.), the subject matter of which is incorporated herein by reference.

However, according to the Document 1, a periodic change in the driving frequency of the working coil causes audible noise during the driving of the working coil. The audible noise generated during the driving of the working coil may be an inconvenience to a user.

Under the circumstances, there is a need for a new induction heating apparatus and a method for controlling the same that decrease a level of EMI that is generated while a working coil operates and that reduces noise generated in the working coil.

### BRIEF DESCRIPTION OF THE DRAWINGS

The embodiments will be described in detail with reference to the following drawings in which like reference numerals refer to like elements and wherein:

FIG. 1 is an exploded perspective view showing an induction heating apparatus of one embodiment;

FIG. 2 is a block diagram showing the induction heating apparatus of one embodiment;

FIG. 3 is a view showing waveforms of a driving frequency that changes depending on a driving frequency control method of an induction heating apparatus in a first embodiment;

FIG. 4 is a view showing waveforms of a driving frequency that changes depending on a driving frequency control method of an induction heating apparatus in a second embodiment;

FIG. 5 is a view showing waveforms of a driving frequency that changes depending on a driving frequency control method of an induction heating apparatus in a third embodiment;

FIG. 6 is a view showing waveforms of a driving frequency that changes based on a linear interpolation function in the third embodiment;

FIG. 7 is a flow chart showing a method for controlling of an induction heating apparatus of one embodiment; and

FIG. 8 shows the magnitude of conductive noise voltage measured when a working coil operates in a state in which a driving frequency of the working coil is fixed to a target frequency, and the magnitude of conductive noise voltage measured when a working coil operates based on a driving frequency of the working coil that is changed according to the third embodiment.

### DETAILED DESCRIPTION

The above-described aspects, features and advantages are specifically described hereafter with reference to the accompanying drawings such that one having ordinary skill in the art to which the present disclosure pertains can easily implement the technical spirit of the disclosure. In the disclosure, detailed descriptions of known technologies in relation to the disclosure are omitted if they are deemed to make the gist of the disclosure unnecessarily vague. Hereafter, preferred embodiments according to the disclosure are specifically described with reference to the accompanying drawings. In the drawings, identical reference numerals can denote identical or similar components.

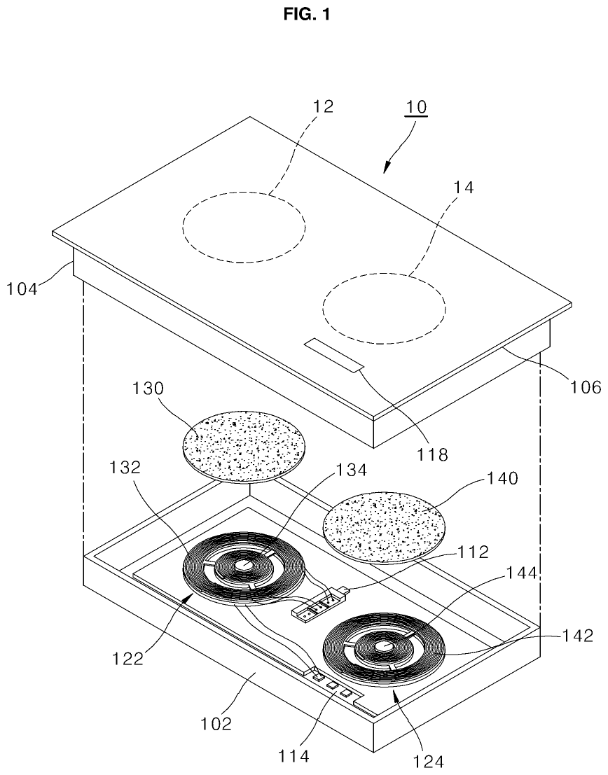

FIG. 1 is an exploded perspective view showing an induction heating apparatus of one embodiment. The induction heating apparatus 10 of one embodiment includes a case 102 constituting a main body, and a cover plate 104 coupled to the case 102 and sealing the case 102.

The cover plate 104 is coupled to the upper surface of the case 102, and seals a space, formed inside the case 102, from the outside. The cover plate 104 includes an upper plate 106 on which a container used for cooking a food item is provided. In one embodiment, the upper plate 106 may be made of tempered glass such as ceramic glass, but may be made of different materials depending on embodiments.

A first heating area (or heating zone) 12 and a second heating area (or heating zone) 14, respectively corresponding to a working coil assembly 122, 124, are formed on the upper plate 106. For a user to recognize the position of the heating area (or heating zone) 12, 14 clearly, a line or a figure corresponding to the heating area (or heating zone) 12, 14 is printed or marked on the upper plate 106. The number and forms (circle, oval, square, rectangular, etc.) or sizes of the one or more heating zones is not limited.

The case 102 may be formed into a cuboid the upper portion of which is open. The working coil assembly 122, 124 for heating a container is disposed in the space formed inside the case 102. Additionally, an interface 114 is disposed inside the case 102, and the interface 114 allows the user to supply power or to adjust a power level of each of the heating areas (or heating zones) 12, 14 and displays information on the induction heating apparatus 10. The interface 114 may be implemented as a touch panel or as a button or knob based operation panel that allows of a touch-based or normal input of in-formation and/or a display of information, but an interface 114 having a different structure may be used depending on embodiments. The display may be placed a location distant from the touch input device or button based input device.

A manipulation area 118 is disposed on the upper plate 106 in a position corresponding to the interface 114. For the user's manipulation, characters or images and the like may be printed in the manipulation area 118, in advance. The user may perform a desired manipulation by touching a specific point of the manipulation area 118 with reference to the characters or images that are printed in the manipulation area 118, in advance. Information output by the interface 114 may be displayed through the manipulation area 118.

The user may set a power level of each of the heating areas (or heating zones) 12, 14 through the interface 114. Power levels may be marked in the manipulation area 118 as numbers (e.g., 1, 2, 3, . . . , 9). When a power level of each of the heating areas (or heating zones) 12, 14 is set, a required power value and a heating frequency of a working coil corresponding to each of the heating areas (or heating zones) 12, 14 are determined. A controller drives each working coil such that an actual output power value of each working coil matches the required power value set by the user, based on the determined heating frequency.

A power supply 112 for supplying power to the first working coil assembly 122, the second working coil assembly 124, and the interface 114 is disposed in the space formed inside the case 102.

The embodiment of FIG. 1 shows two working coil assemblies (i.e., the first working coil assembly 122 and the second working coil assembly 124) disposed in the case 102, for example. However, three or more working coil assemblies may be disposed in the case 102 depending on embodiments.

The working coil assemblies 122, 124 include a working coil that forms an induction magnetic field by using high-frequency AC current supplied by the power supply 112, and an insulating sheet that protects the coil from heat generated by a container. FIG. 1 shows that the first working coil assembly 122 includes a first working coil 132 for heating a container provided in the first heating area (or heating zone) 12, and a first insulating sheet 130, and that the second working coil assembly 124 includes a second working coil 142 for heating a container provided in the second heating area (or heating zone) 14, and a second insulating sheet 140, for example. The insulating sheet may be excluded depending on embodiments.

A temperature sensor is disposed in the central portion of each of the working coils 132, 142. FIG. 1 shows that a temperature sensor 134 is disposed in the central portion of the first working coil 132, and that a second temperature sensor 144 is disposed in the central portion of the second working coil 142, for example. The temperature sensor measures a temperature of a container provided in each of the heating areas (or heating zones). In one embodiment, the temperature sensor may be a thermistor having resistance values that vary depending on a temperature of a container, but not limited thereto.

In one embodiment, the temperature sensor outputs sensing voltage corresponding to a temperature of a container, and the sensing voltage output from the temperature sensor is delivered to the controller. The controller ascertains a temperature of a container based on magnitude of the sensing voltage output from the temperature sensor, and when the temperature of the container is a predetermined reference value or higher, performs an overheat preventing operation by lowering an actual power value of a working coil or by stopping the driving of a working coil.

A board onto which a plurality of circuits or elements including the controller is mounted may be disposed in the space formed inside the case 102.

The controller may drive each of the working coils 132, 142 to perform a heating operation, according to the user's instruction for initiating heating input through the interface 114. When the user inputs an instruction for ending heating through the interface 114, the controller stops the driving of the working coil 132, 142 to end the heating operation,

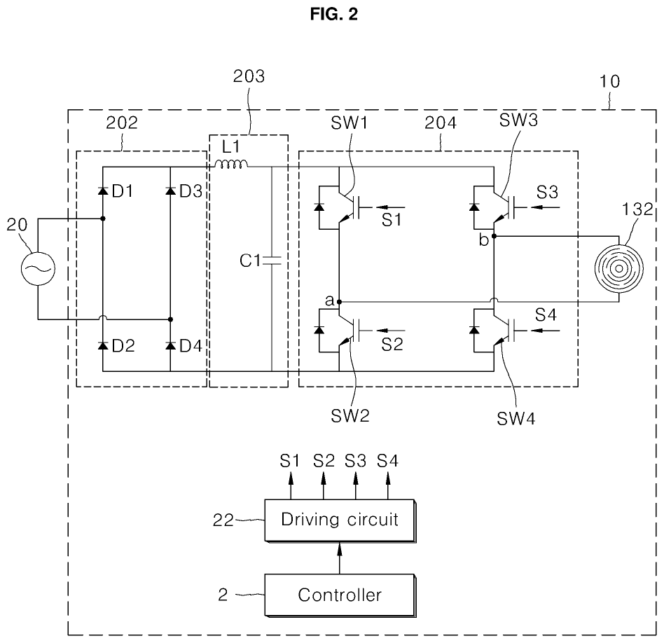

FIG. 2 is a block diagram showing the induction heating apparatus of one embodiment. The induction heating apparatus 10 of one embodiment includes a rectifying circuit 202, a smoothing circuit L1, C1, an inverter circuit 204 (or inverter), the first working coil 132, a controller 2, and a driving circuit 22 (or drive circuit). Hereafter, an example of control over the driving of the first working coil 132 is described. However, a method for controlling the induction heating apparatus according to the present disclosure is also applied to the second working coil 142.

The rectifying circuit 202 (or rectifier) includes a plurality of diode elements D1, D2, D3, D4. As illustrated in FIG. 2, the rectifying circuit 202 may be a bride diode circuit, and depending on embodiments, may be another type of circuit. The rectifying circuit 202 rectifies AC input voltage supplied from a power supply device 20 (or power supply) and outputs voltage having a pulse waveform.

The smoothing circuit 203 smooths the voltage rectified by the rectifying circuit 202 and outputs DC link voltage. The smoothing circuit 203 includes a first inductor L1 and a DC link capacitor C1.

The inverter circuit 204 includes a first switching element SW1, a second switching element SW2, a third switching element SW3, and a fourth switching element SW4. Other switching elements may also be provided. As illustrated in FIG. 2, the inverter circuit 204 of the induction heating apparatus 10 of one embodiment is embodied as a full bridge circuit including four switching elements SW1, SW2, SW3, SW4. However, in another embodiment, the inverter circuit 204 may be embodied as a half bridge circuit including two switching elements (e.g., a first switching element SW1 and a second switching element SW2).

The first switching element SW1, the second switching element SW2, the third switching element SW3, and the fourth switching element SW4 are respectively turned on and turned off by a first switching signal S1, a second switching signal S2, a third switching signal S3, and a fourth switching signal S4. Each of the switching elements SW1, SW2, SW3, SW4 is turned on when each of the switching signals S1, S2, S3, S4 is at a high level, and is turned off when each of the switching signals S1, S2, S3, S4 is at a low level.

FIG. 2 shows that each of the switching elements SW1, SW2, SW3, SW4 is an IGBT element, for example. However, each of the switching elements SW1, SW2, SW3, SW4 may be another type of switching element (e.g., a BJT or FET and the like) depending on embodiments.

Any of the switching elements SW1, SW2, SW3, SW4 may be turned on and turned off alternately. For example, in any operation mode, while the first switching element SW1 is turned on (turned off), the second switching element SW2 may be turned off (turned on). In the present disclosure, the switching elements that are turned on and turned off alternately and mutually are referred to as ‘mutually alternate’ switching elements.

Any of the switching elements SW1, SW2, SW3, SW4 may be turned on and turned off at a same timing. For example, in any operation mode, the first switching element SW1 and the third switching element SW3 may be turned on and turned off on the same timing. In the present disclosure, the switching elements that are turned on and turned off on the same timing are referred to as ‘switching elements belonging to the same group’.

The first switching element SW1 and the third switching element SW3 are referred to as switching elements belonging to a first group (i.e., a high side group), and the second switching element SW2 and the fourth switching element SW4 are referred to as switching elements belonging to a second group (i.e., a low side group).

If the inverter circuit 204 is embodied as a half bridge circuit (i.e., a circuit including only the first switching element SW1 and the second switching element SW2), in another embodiment, the first switching element SW1 belongs to the first group or the high side group, and the second switching element SW2 belongs to the second group or the low side group.

As a result of the turn-on and turn-off operations (i.e., the switching operations) of the switching elements SW1, SW2, SW3, SW4, included in the inverter circuit 204, the DC link voltage input to the inverter circuit 204 is converted into alternating current. The alternating current converted by the inverter circuit 204 is provided (or supplied) to the first working coil 132. As resonance occurs in the first working coil 132, eddy current flows in a container, and the container is heated.

In the present disclosure, each of the first switching signal S1, the second switching signal S2, the third switching signal S3 and the fourth switching signal S4 is a pulse width modulation (PWM) signal having a predetermined duty cycle.

As the alternating current output from the inverter circuit 204 is supplied to the first working coil 132, the first working coil 132 operates. As the first working coil 132 operates, a container provided on the first working coil 132 is heated while eddy current flows in the container. The magnitude of thermal energy supplied to the container varies depending on magnitude of the power that is actually generated as the first working coil 132 operates (i.e., an actual output power value of the working coil).

When the induction heating apparatus 10 is turned on (powered on) as a result of the user's manipulation of the interface of the induction heating apparatus 10, the induction heating apparatus is on standby for driving as power is supplied from the power supply device 20 to the induction heating apparatus. The user then provides a container on a working coil of the induction heating apparatus, and gives an instruction for initiating heating of the working coil by setting a power level for the container. As the user gives the instruction for initiating heating, a value of power required of the first working coil 132 (i.e., a required power value) is determined based on the power level set by the user.

Having received, from the user, the instruction for initiating heating, the controller 2 determines a frequency corresponding to the required power value of the first working coil 132 (i.e., a heating frequency), and provides (or supplies) a control signal corresponding to the determined heating frequency to the driving circuit 22. Accordingly, the switching signals S1, S2, S3, S4 are output from the driving circuit 22, and as the switching signals S1, S2, S3, S4 are input respectively into the switching elements SW1, SW2, SW3, SW4, the first working coil 132 operates. As the first working coil 132 operates, the container is heated while eddy current flows in the container.

In one embodiment, the controller 2 determines a heating frequency that is a frequency corresponding to a power level of a heating area (or heating zone) set by the user. For example, as the user sets a power level of a heating area (or heating zone), the controller 2 may gradually decrease a driving frequency of the inverter circuit 204 until an output power value of the first working coil 132 matches a required power value corresponding to the power level set by the user, in a state in which the driving frequency of the inverter circuit 204 is set to a predetermined reference frequency. The controller 2 may determine a frequency at a time when the output power value of the first working coil 132 matches the required power value as a heating frequency.

The controller 2 supplies a control signal corresponding to the determined heating frequency to the driving circuit 22. The driving circuit 22 outputs switching signals S1, S2, S3, S4 having a duty ratio corresponding to the heating frequency determined by the controller 2, based on the control signal output from the controller 2. As the switching signals S1, S2, S3, S4 are input, alternating current is supplied to the first working coil 132 while the switching elements SW1, SW2, SW3, SW4 are turned on and turned off alternately.

In one embodiment, the controller 2 changes a driving frequency of the first working coil 132, based on a predetermined change cycle, after the heating frequency is determined. Accordingly, an EMI level of the induction heating apparatus 10 may decrease. Further, based on the above-described control, noise generated by the first working coil 132 may be minimized while the driving frequency of the first working coil 132 changes.

For example, in one embodiment, the controller 2 sets the driving frequency of the first working coil 132 to an initial frequency determined based on the heating frequency after the heating frequency is determined, and drives the first working coil 132.

Additionally, in one embodiment, the controller 2 changes the driving frequency of the first working coil 132 from a current driving frequency to a target frequency, based on the predetermined frequency change cycle.

In one embodiment, the target frequency is a value that changes randomly.

In one embodiment, the driving frequency of the first working coil 132 increases or decreases linearly within each frequency change cycle.

Hereafter, described are examples of a change in the driving frequency of the first working coil 132 during the first working coil 132's driving by the controller 2 after the determination of the heating frequency of the first working coil 132.

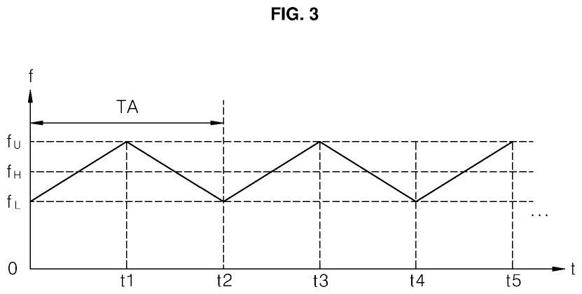

FIG. 3 is a view showing waveforms of a driving frequency that changes depending on a driving frequency control method of an induction heating apparatus in a first embodiment. In the FIG. 3 embodiment, as the heating frequency of the first working coil 132 is determined, the controller 2 determines an upper limit frequency fU and a lower limit frequency fL respectively, based on the heating frequency fH of the first working coil 132. For example, the controller 2 may calculate (or determine) an upper limit frequency fU by adding a predetermined offset value to the heating frequency fH, and calculate (or determine) a lower limit frequency fL by deducting the predetermined offset value from the heating frequency fH. The offset value is a value that may be set differently depending on embodiments.

As the upper limit frequency fU and the lower limit frequency fL are determined respectively, the controller 2 changes the driving frequency of the first working coil 132, based on a predetermined change cycle TA. As illustrated in FIG. 3, the controller 2 increases the driving frequency of the first working coil 132 from the lower limit frequency fL to the upper limit frequency fU linearly and then decreases the driving frequency of the first working coil 132 from the upper limit frequency fU to the lower limit frequency fL linearly, within each change cycle TA. In FIG. 3, the length of each section 0-t2, t2-t4, . . . is all identical with the change cycle TA.

In another embodiment, the controller 2 may perform the control method described with reference to FIG. 3, based on another value rather than the upper limit frequency fU and the lower limit frequency fL.

In the embodiment of FIG. 3, the driving frequency of the first working coil 132 changes based on a predetermined value (e.g., an upper limit frequency fU and a lower limit frequency fL), on a regular basis. Accordingly, the waveform of the driving frequency of the first working coil 132 in each change cycle has a symmetrical shape. Additionally, the waveform of the driving frequency of the first working coil 132 in each change cycle is identical and repeated.

When the driving frequency of the first working coill 132 is changed to have repetitive and symmetrical waveforms based on the predetermined cycle TA as in the embodiment of FIG. 3, the EMI level is reduced compared to the case in which the first working coil 132 operates in a state in which the driving frequency of the first working coil 132 is fixed to the heating frequency fH.

However, in the embodiment of FIG. 3, since the driving frequency has repetitive and symmetrical waveforms based on the predetermined cycle TA, a change frequency 1/TA of the driving frequency can be generated. If the change frequency 1/TA of the driving frequency is included in an audible frequency band (e.g., 2 kHz-15 kHz), noise caused by a periodic change in the driving frequency of the first working coil 132 may be generated.

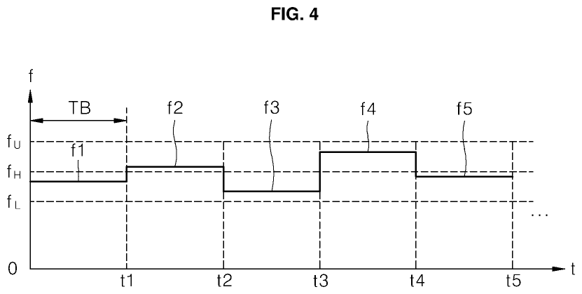

FIG. 4 is a view showing waveforms of a driving frequency that changes depending on a driving frequency control method of an induction heating apparatus in a second embodiment.

As the heating frequency of the first working coil 132 is determined, the controller 2 determines an upper limit frequency fU and a lower limit frequency fL respectively, based on the heating frequency fH of the first working coil 132. For example, the controller 2 may calculate (or determine) an upper limit frequency fU by adding a predetermined offset value to the heating frequency fH, and calculate (or determine) a lower limit frequency fL by deducting the predetermined offset value from the heating frequency fH. The offset value is a value that may be set differently depending on embodiments.

As the upper limit frequency fU and the lower limit frequency fL are determined respectively, the controller 2 selects a random value in each predetermined change cycle TB and sets the selected random value to the driving frequency of the first working coil 132. The random value selected in each change cycle TB may be any value selected from among values that are equal to or less than the upper limit frequency fU and that are equal to or greater than the lower limit frequency fL.

For example, the controller 2 sets the driving frequency of the first working coil 132 to f1, a randomly selected value, in section 0-t1, as illustrated in FIG. 4. Additionally, the controller 2 sets the driving frequency of the first working coil 132 to f2, a randomly selected value, in the following section t1-t2. In the same way, the controller 2 sets the driving frequency of the first working coil1 132 to randomly selected values f3, f4, f5, . . . respectively in the following sections t2-t3, t3-t4, t4-t5, . . . . In FIG. 4, the length of each section 0-t1, t1-t2, t2-t3, t3-t4, t4-t5, . . . is all identical with the change cycle TB.

Additionally, in the embodiment of FIG. 4, the driving frequency of the first working coil 132 is maintained at a constant value f1, f2, f3, f4, f5, . . . in each section 041, t1-t2, t2-t3, t3-t4, t4-t5, . . . without increasing or decreasing.

When the driving frequency of the first working coil 132 is changed as illustrated in FIG. 4, the EMI level is reduced compared to the case in which the first working coil 132 operates in the state in which the driving frequency of the first working coil 132 is fixed to the heating frequency fH.

Further, unlike the embodiment of FIG. 3, the embodiment of FIG. 4 shows that the waveforms of the driving frequency of the first working coil 132 are asymmetrical since the driving frequency is randomly selected in each change cycle TB. A change frequency of the driving frequency, which is generated in the embodiment of FIG. 3, is not generated. However, in the embodiment of FIG. 4, the first working coil 132's noise may be caused by a rapid change in the driving frequency at each time point t1, t2, t3, t4, t5, . . .

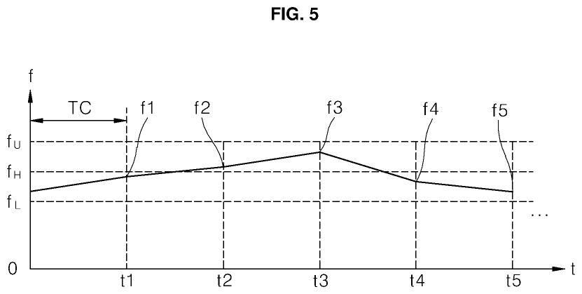

FIG. 5 is a view showing waveforms of a driving frequency that changes depending on a driving frequency control method of an induction heating apparatus in a third embodiment.

As the heating frequency of the first working coil 132 is determined, the controller 2 determines an upper limit frequency fU and a lower limit frequency fL respectively, based on the heating frequency fH of the first working coil 132. For example, the controller 2 may calculate (or determine) an upper limit frequency fU by adding a predetermined offset value to the heating frequency fH, and calculate (or determined) a lower limit frequency fL by deducting the predetermined offset value from the heating frequency fH. The offset value is a value that may be set differently depending on embodiments.

As the upper limit frequency fU and the lower limit frequency fL are determined respectively, the controller 2 determines an initial frequency f0, based on the heating frequency fH. In one embodiment, the initial frequency f0 may be any value selected from among values that are equal to or less than the upper limit frequency fU and that are equal to or greater than the lower limit frequency fL.

As the initial frequency f0 is determined, the controller 2 sets the driving frequency of the first working coil 132 to the initial frequency f0 and drives the first working coil 132.

The controller 2 then selects a random value in each predetermined change cycle TC and sets the selected random value to a target frequency of the first working coil 132. The random value selected in each change cycle TC may be any value that is selected from among values that are equal to or less than the upper limit frequency fU and that are equal to or greater than the lower limit frequency fL.

In FIG. 5, the controller 2 sets randomly selected value f1 to the target frequency of the first working coil 132 in a state in which the first working coil 132 operates at the initial frequency f0, for example.

As the target frequency is set, the controller 2 increases or decreases the driving frequency of the first working coil 132 linearly from a current driving frequency to the target frequency.

For example, the controller 2 increases the driving frequency of the first working coil 132 linearly from the current driving frequency f0 to the target driving frequency f1 in the state in which the first working coil 132 operates at the initial frequency f0.

The controller 2 then sets value f2 randomly selected at time point t1 to the target frequency, and increases the diving frequency of the first working coil 132 linearly from the current driving frequency f1 to the target frequency f2.

In the same way, the controller 2 linearly increases the driving frequency of the first working coil 132 to f3, f4, f5, . . . . or linearly decreases the driving frequency of the first working coil 132 to f5, f4, f3, . . . ., based on the change cycle TC.

When the driving frequency of the first working coil 132 is changed as illustrated in FIG. 5, the EMI level is reduced compared to the case in which the first working coil 132 operates in the state in which the driving frequency of the first working coil 132 is fixed to the heating frequency fH.

Additionally, unlike the embodiment of FIG. 3, the embodiment of FIG. 5 shows that the waveforms of the driving frequency of the first working coil 132 are asymmetrical since the driving frequency of the first working coil 132 is randomly selected in each change cycle TC. Thus, a change frequency of the driving frequency, which is generated in the embodiment of FIG. 3, is not generated. Further, unlike the embodiment of FIG. 4, the embodiment of FIG. 5 shows that the driving frequency of the first working coil 132 does not rapidly change at each time point t1, t2, t3, t4, t5, . . . since the driving frequency of the first working coil 132 increases or decreases linearly in each change cycle TC. Thus, noise is not generated while the driving frequency of the first working coil 132 changes.

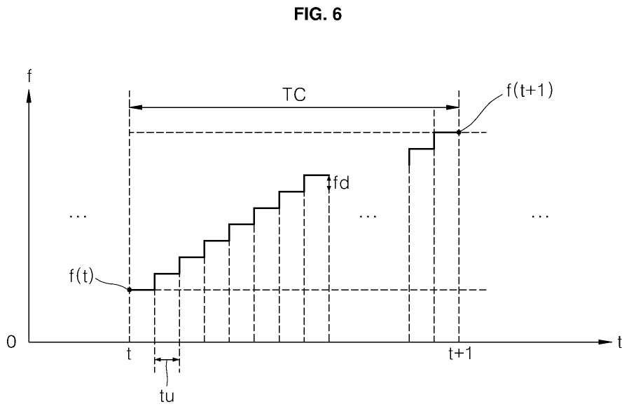

FIG. 6 is a view showing waveforms of a driving frequency that changes based on a linear interpolation function in the third embodiment.

In the third embodiment, the driving frequency of the first working coil 132 increases or decreases linearly in each change cycle TC, as described with reference to FIG. 5. In this case, the driving frequency of the first working coil 132 may change within each change cycle TC based on a linear interpolation function as illustrated in FIG. 6.

For example, the driving frequency of the first working coil 132 is f(t) at time point t, and may increase to f(t+1) based on the linear interpolation function (a step function) of FIG. 6 till time point t+1 at which the change cycle TC passes, as illustrated in FIG. 6.

In one embodiment, the linear interpolation function may be defined based on a predetermined unit interpolation cycle or a predetermined unit frequency change value.

For example, when the unit interpolation cycle tu is set previously in the embodiment of FIG. 6, the unit frequency change value fd may be determined based on a difference between f(t+1) and f(t), the unit interpolation cycle tu, and the change cycle TC. In another example, when the unit frequency change value fd is determined previously in the embodiment of FIG. 6, the unit interpolation cycle tu may be determined based on the difference between f(t+1) and f(t), the unit frequency change value fd, and the change cycle TC.

As the unit interpolation cycle tu and the unit frequency change value fd are determined, the linear interpolation function (a step function) as illustrated in FIG. 6 may be determined. The controller 2 increases the driving frequency of the first working coil 132 by the unit frequency change value fd in each unit interpolation cycle tu, based on the determined linear interpolation function. Accordingly, as the change cycle TC passes, the driving frequency of the first working coil 132 increases from f(t) to f(t+1).

The unit interpolation cycle tu and the unit frequency change value fd may be set differently depending on embodiments.

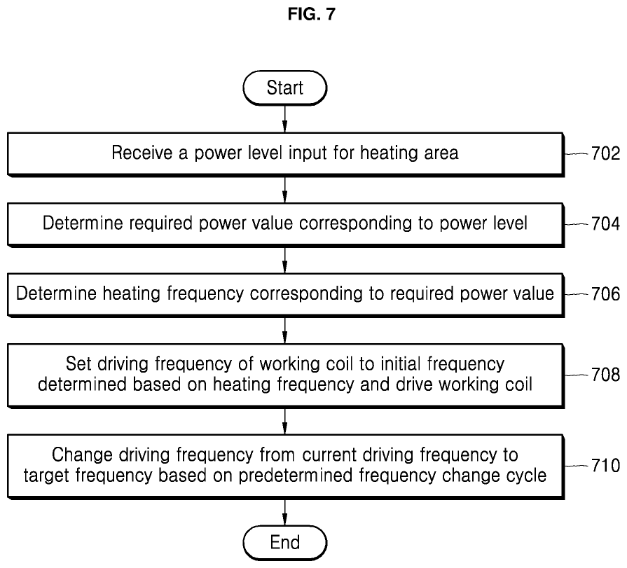

FIG. 7 is a flow chart showing a method for controlling of an induction heating apparatus of one embodiment. The controller 2 of the induction heating apparatus 10 of one embodiment receives a power level input for a heating area (or heating zone) (702).

The controller 2 determines a required power value corresponding to the power level (704). For example, when the power level input for the heating area (or heating zone) is 2, the required power value may be determined as 600 W, and when the power level input is 8, the required power value may be determined as 2000 W.

The controller 2 determines a heating frequency corresponding to the required power value (706). For example, when the required power value is 600 W, the heating frequency may be determined as 40 kHz, and when the required power value is 2000 W, the heating frequency may be determined as 32 kHz.

The controller 2 sets a driving frequency of a working coil to an initial frequency determined based on the heating frequency, and drives the working coil (708). In one embodiment, the controller 2 may determine an upper limit frequency and a lower limit frequency, based on the heating frequency. Additionally, the controller 2 may set the initial frequency to a value that is equal to or less than the upper limit frequency and that is equal to or greater than the lower limit frequency.

As the working coil operates at the initial frequency, the controller 2 changes the driving frequency of the working coil from a current driving frequency to a target frequency, based on a predetermined frequency change cycle (710).

In one embodiment, the target frequency is a value that changes randomly. Additionally, in one embodiment, the target frequency may be set to a value that is equal to or less than the upper limit frequency and that is equal to or greater than the lower limit frequency.

Further, in one embodiment, the driving frequency of the working coil may increase or decrease linearly within each frequency change cycle.

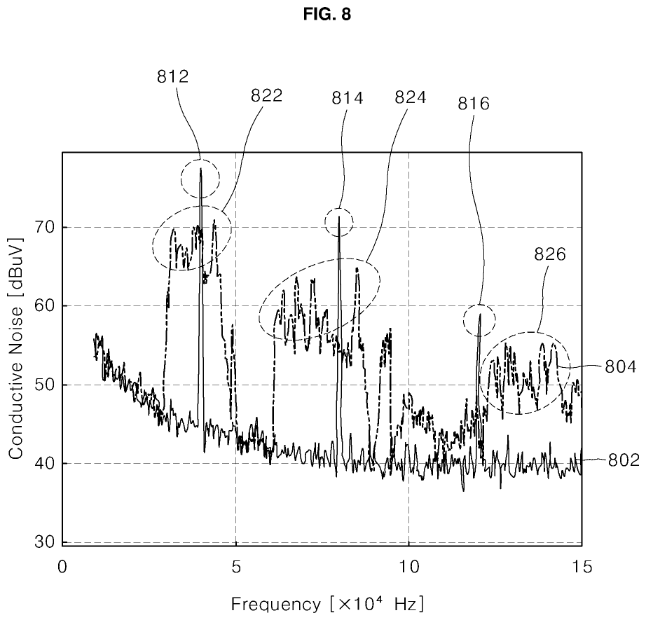

FIG. 8 shows the magnitude of conductive noise voltage measured when a working coil operates in a state in which a driving frequency of the working coil is fixed to a target frequency, and the magnitude of conductive noise voltage measured when a working coil operates based on a driving frequency of the working coil that is changed according to the third embodiment.

FIG. 8 shows magnitude 802 of conductive noise voltage that is measured when the working coil operates in the state in which the driving frequency of the working coil is fixed to a target frequency corresponding to the required power value.

Referring to FIG. 8, as the working coil operates in the state in which the driving frequency of the working coil is fixed to the target frequency, a peak value 812, 814, 816 of the conductive noise voltage increases immediately and rapidly in each harmonic band (i.e., a first harmonic band, a third harmonic band, and a fifth harmonic band). The magnitude of the conductive noise voltage is proportional to an EMI level. As the peak value of the conductive noise voltage increases rapidly, the EMI level becomes very high.

Additionally, FIG. 8 shows that the magnitude 804 of the conductive noise voltage that is measured when the working coil operates, using the control method by which the driving frequency of the working coil changes based on the predetermined frequency change cycle as described with reference to the third embodiment.

Referring to FIG. 8, as the frequency of the working coil changes linearly and randomly based on the predetermined frequency change cycle, the peak value 822, 824, 826 of the conductive noise voltage becomes lower than that of the related art in each harmonic band (i.e., the first harmonic band, the third harmonic band and the fifth harmonic band).

That is, in the method for controlling an induction heating apparatus of the embodiments set forth in the disclosure, the peak value 822, 824, 826 of the conductive noise voltage is lower than a peak value 812, 814, 816 of conductive noise voltage of the disadvantageous arrangement when the working coil operates, thereby ensuring an EMI level lower than that of the disadvantageous arrangement.

The embodiments are described above with reference to a number of illustrative embodiments thereof. However, embodiments are not limited to the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

An object of the present disclosure is to provide an induction heating apparatus and a method for controlling the same that decreases a level of EMI generated during the driving of a working coil and reduces noise generated by the working coil.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

An induction heating apparatus of one embodiment includes a working coil disposed in a position corresponding to a heating area (or heating zone), an inverter circuit comprising a plurality of switching elements and supplying current to the working coil, a driving circuit supplying a switching signal to the inverter circuit, and a controller determining a driving frequency of the working coil, supplying a control signal to the driving circuit based on the driving frequency and driving the working coil.

In one embodiment, the controller receives a power level input for the heating area (or heating zone), determines a required power value corresponding to the power level, determines a heating frequency corresponding to the required power value, sets a driving frequency of the working coil to an initial frequency determined based on the heating frequency and drives the working coil, and changes the driving frequency from a current driving frequency to a target frequency based on a predetermined frequency change cycle.

In one embodiment, the target frequency is a value that changes randomly.

In one embodiment, the driving frequency increases or decreases linearly within each frequency change cycle.

In one embodiment, the controller determines an upper limit frequency and a lower limit frequency based on the heating frequency.

In one embodiment, the initial frequency or the target frequency are set to a value that is equal to or less than the upper limit frequency and that is equal to or greater than the lower limit frequency.

In one embodiment, the driving frequency increases or decreases linearly from the current driving frequency to the target frequency based on a linear interpolation function, within each frequency change cycle.

In one embodiment, the linear interpolation function is defined based on a predetermined unit interpolation cycle or a predetermined unit frequency change value.

In one embodiment, the frequency change cycle changes randomly.

A method for controlling an induction heating apparatus of one embodiment includes receiving a power level input for a heating area (or heating zone), determining a required power value corresponding to the power level, determining a heating frequency corresponding to the required power value, setting a driving frequency of the working coil to an initial frequency determined based on the heating frequency and driving the working coil, and changing the driving frequency from a current driving frequency to a target frequency based on a predetermined frequency change cycle.

In one embodiment, the target frequency is a value that changes randomly.

In one embodiment, the driving frequency increases or decreases linearly within each frequency change cycle.

The method of one embodiment further includes determining an upper limit frequency and a lower limit frequency, based on the heating frequency.

In one embodiment, the initial frequency or the target frequency are set to a value that is equal to or less than the upper limit frequency and that is equal to or greater than the lower limit frequency.

In one embodiment, the driving frequency increases or decreases linearly from the current driving frequency to the target frequency, based on a linear interpolation function, within each frequency change cycle.

In one embodiment, the linear interpolation function is defined based on a predetermined unit interpolation cycle or a predetermined unit frequency change value.

In one embodiment, the frequency change cycle changes randomly.

According to embodiments, a level of EMI generated during the driving of a working coil of an induction heating apparatus, and noise generated by the working coil decrease.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An induction heating apparatus, comprising:
a working coil disposed to correspond to a heating area;
an inverter comprising a plurality of switching elements, and configured to provide current to the working coil;
a driving circuit for providing a switching signal to the inverter; and
a controller configured to:
receive a power level for the heating area,
determine a required power value corresponding to the power level,
determine a heating frequency corresponding to the required power value,
set a driving frequency of the working coil to an initial frequency determined based on the heating frequency, and drive the working coil based on the set driving frequency, and
change the driving frequency from a current driving frequency to a target frequency based on a frequency change cycle,
wherein the target frequency is a value that changes randomly.

2. The induction heating apparatus of claim 1, wherein the controller is configured to:
determine an upper limit frequency, based on the determined heating frequency,
determine a lower limit frequency based on the determined heating frequency, and
determine the initial frequency to be a value that is equal to or less than the upper limit frequency and that is equal to or greater than the lower limit frequency.

3. The induction heating apparatus of claim 2, wherein the controller is configured to:
determine the target frequency to be equal to or less than the upper limit frequency and to be equal to or greater than the lower limit frequency.

4. The induction heating apparatus of claim 1, wherein the change of the driving frequency from the current driving frequency to the target frequency includes linearly increasing the driving frequency from the current driving frequency to the target frequency, within the change cycle.

5. The induction heating apparatus of claim 1, wherein the change of the driving frequency from the current driving frequency to the target frequency includes linearly decreasing the driving frequency from the current driving frequency to the target frequency, within the change cycle.

6. The induction heating apparatus of claim 1, wherein the change of the driving frequency from the current driving frequency to the target frequency includes changing the driving frequency from the current driving frequency to the target frequency based on a linear interpolation function, within the change cycle.

7. The induction heating apparatus of claim 6, wherein the linear interpolation function is defined based on a predetermined unit interpolation cycle or a predetermined unit frequency change value.

8. The induction heating apparatus of claim 1, wherein the driving frequency increases or decreases linearly within each frequency change cycle.

9. A method of an induction heating apparatus, comprising:
receiving a power level for a heating area;
determining a required power value corresponding to the power level;
determining a heating frequency corresponding to the required power value;
setting a driving frequency of the working coil to an initial frequency determined based on the heating frequency, and driving the working coil based on the set driving frequency; and
changing the driving frequency from a current driving frequency to a target frequency based on a frequency change cycle,
wherein the target frequency is a value that changes randomly.

10. The method of claim 9, further comprising:
determining an upper limit frequency based on the heating frequency,
determining a lower limit frequency based on the heating frequency, and
determining the initial frequency to be a value that is equal to or less than the upper limit frequency and that is equal to or greater than the lower limit frequency.

11. The method of claim 10, further comprising:
determining the target frequency to be equal to or less than the upper limit frequency and to be equal to or greater than the lower limit frequency.

12. The method of claim 9, wherein the changing of the driving frequency from the current driving frequency to the target frequency includes linearly increasing the driving frequency from the current driving frequency to the target frequency, within the change cycle.

13. The method of claim 9, wherein the changing of the driving frequency from the current driving frequency to the target frequency includes linearly decreasing the driving frequency from the current driving frequency to the target frequency, within the change cycle.

14. The method of claim 9, wherein the changing of the driving frequency from the current driving frequency to the target frequency includes changing the driving frequency from the current driving frequency to the target frequency based on a linear interpolation function, within the change cycle.

15. The method of claim 14, wherein the linear interpolation function is defined based on a predetermined unit interpolation cycle or a predetermined unit frequency change value.

16. An induction heating apparatus, comprising:
a working coil disposed to correspond to a heating area;
an inverter comprising a plurality of switching elements, and configured to provide current to the working coil;
a controller configured to:
receive a power level for the heating area,
determine a heating frequency based on the received power level,
set a driving frequency of the working coil based on the heating frequency, and drive the working coil based on the set driving frequency,
change the driving frequency from a current driving frequency to a first target frequency during a first frequency change cycle, and
change the driving frequency from the first target frequency to a second target frequency during a second frequency change cycle.

17. The induction heating apparatus of claim 16, wherein the controller is further configured to:
change the driving frequency from the second target frequency to a third target frequency during a third frequency change cycle.

18. The induction heating apparatus of claim 16, wherein the change of the driving frequency from the current driving frequency to the first target frequency includes linearly increasing the driving frequency from the current driving frequency to the first target frequency, within the first frequency change cycle.

19. The induction heating apparatus of claim 16, wherein the change of the driving frequency from the current driving frequency to the first target frequency includes linearly decreasing the driving frequency from the current driving frequency to the first target frequency, within the first frequency change cycle.

20. The induction heating apparatus of claim 16, wherein the change of the driving frequency from the current driving frequency to the first target frequency includes changing the driving frequency from the current driving frequency to the first target frequency based on a linear interpolation function, within the first frequency change cycle.
